(19) United States
(12) Patent Application Publication
(10) Pub. No.: US 2026/0039910 A1
(43) Pub. Date: Feb. 5, 2026

(54) SYSTEMS AND METHODS FOR GENERATING MEMBERSHIP TIER NAMES FOR A CHANNEL USING ARTIFICIAL INTELLIGENCE

(71) Applicant: Google LLC, Mountain View, CA (US)

(72) Inventors: Dhruv Bakshi, Zug (CH); Briana Yvonne Seiderman, Zurich (CH)

(21) Appl. No.: 19/287,274

(22) Filed: Jul. 31, 2025

Related U.S. Application Data
(60) Provisional application No. 63/677,835, filed on Jul. 31, 2024.

(51) Int. Cl. H04N 21/45

(52) U.S. Cl. CPC H04N 21/4508

(57) ABSTRACT

A method includes identifying, by a processing device of a content sharing platform, a channel that offers a plurality of membership tiers to users of the content sharing platform. Using one or more artificial intelligence (AI) models and a first prompt, data pertaining to content of the channel is generated. For each membership tier of the plurality of membership tiers, using the one or more AI models and a second prompt, a set of names reflecting the content of the channel is determined. For each membership tier, a recommendation reflecting a respective name selected from the set of names is generated and based on the recommendation, a respective tier name field associated with each membership tier is prefilled.

### RELATED APPLICATION

This application claims the benefit of U.S. Provisional Application No. 63/677,835, filed Jul. 31, 2024, the entire content of which is hereby incorporated by reference.

### TECHNICAL FIELD

The disclosed implementations relate to methods and systems for generating membership tier names for a channel using artificial intelligence.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes identifying, by a processing device of a content sharing platform, a channel that offers a plurality of membership tiers to users of the content sharing platform. Using one or more artificial intelligence (AI) models and a first prompt, data pertaining to content of the channel is generated. For each membership tier of the plurality of membership tiers, using the one or more AI models and a second prompt, a set of names reflecting the content of the channel is determined. For each membership tier, a recommendation reflecting a respective name selected from the set of names is generated and based on the recommendation, a respective tier name field associated with each membership tier is prefilled.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIGS. 2A-2B are example graphical user interfaces (GUIs) illustrating operation of an example tier name generation tool, in accordance with implementations of the disclosure.

FIG. 3 is a diagram showing an example set of custom badges provided to members of a channel, in accordance with implementations of the disclosure.

FIG. 4 depicts a flow diagram of an example method for generating tier names, in accordance with implementations of the disclosure.

FIG. 5 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channel”). A channel can be data content available from a common source or data content having a common topic, theme, or substance. The channel can be associated with a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that visually represents the channel, etc.

Channel owners can enable certain content-related features to monetize their channel(s). For example, content creators can realize earnings from advertisements (“ads”) that would appear during certain segments of certain media items, receive revenue from viewers via a gratuity feature, sell merchandise, etc. In some instances, channel owners can generate revenue by enabling channel memberships that offer viewers (e.g., users of the content sharing platform) one or more particular tiers of content access (referred to as a “membership tier”). A membership can represent a feature of the content sharing platform that allows “members” to join a channel through monthly fees and receive members-only benefits also referred to as privileges. Membership can provide different privileges such as access to exclusive content (content not made available to non-members), badges, emojis, access to live-streams, chats and/or other bonus content that only members can access.

In certain instances, a particular channel can include multiple membership tiers, where each tier (or level) can include different privileges for a different monthly fee. Each tier can have a specific name assigned by the channel owner. However, in many instances, the channel owner may have difficulty determining tier names that are not only related to the content offered by the channel, but also catchy and reflect a progression in naming that highlights the tiers of higher value. This difficulty may cause the channel owner to review their videos and other content on their channel in the hopes of identifying fitting names for their tiers, thus causing the channel owner to waste considerable time and computing resources. Further, failure to properly label the tiers with memorable or catchy names can lead to a reduced conversion rate of new members, thus causing the channel owner and the content sharing platform to miss out on potential revenue.

Aspects and implementations of the present disclosure address the above and other deficiencies by providing a system for generating membership tier names using artificial intelligence. In particular, during the setup process for channel memberships, the channel owner can select a number of membership tiers to offer viewers. The system of the present disclosure can then generate a name for each membership tier (e.g., a respective title or label assigned to each corresponding membership tier). The names can reflect the content of the channel and a progression in naming that highlights tiers of higher value. In addition, the system of the present disclosure can generate multiple sets of tier names, allowing the channel owner to review different options for assignment.

In some implementations, the system of the present disclosure can use one or more artificial intelligence models, such as one or more large language models (LLMs) to generate names for membership tiers. A LLM is designed to understand and generate human-like text by analyzing and processing vast datasets of language from books, articles, and/or the internet. To generate the names, the present system can generate a set of input prompts for the LLM. Each input prompt can contain instructions for the LLM and serve to guide the output of the LLM. In particular, a first input prompt can include instructions to summarize the content posted on and/or related to a channel. The first prompt can instruct the LLM to generate, using the channel's description, one or more media items of the channel (e.g., such as the titles of a set of recent media items, the titles of a set of most popular media items, etc.), metadata related to the channel (e.g., type of content posted, channel owner characteristics, etc.) and so forth, output data reflecting this summary. A second input prompt can then instruct the LLM to generate, based on the output data reflecting the channel summary, output data reflecting a set of tier names (e.g., a set of 100 tier names where each set includes a name for each tier). A third input prompt can then instruct the LLM to select a subset from the set of tier names (e.g., the best 20 tier names), and, in some instances, to filter the set or subset such that tier names with one or more sensitive words (e.g., words that are offensive, rude, disrespectful, hurtful, sexual, etc.) are excluded. Using the output data reflecting the subset, the present system can, in response to the selection of a UI element (e.g., a generate names button), automatically pre-fill the tier name fields related to the membership tiers.

Aspects of the present disclosure result in improved performance of channel membership tools. In particular, the aspects of the present disclosure enable generating channel tier names for channel owners. As a result, the channel owner is able to conserve time and computing resources when setting up membership tiers. Further, by generating memorable or catchy names, the conversion rate for new members can be improved. In addition, the aspects of the present disclosure enable the system to use an iterative prompting technique where each new prompt is dynamically generated based on the previous output to guide the AI model towards the final result. This allows for more efficient use of the AI model because, instead of handling one large, intricate task, the AI model solves simpler, more focused tasks at each stage (e.g., at each prompt). Specifically, by breaking down the task, the system reduces the cognitive load on the AI model, which can significantly lower the likelihood of errors, omissions, or and/or undesired results in the final output.

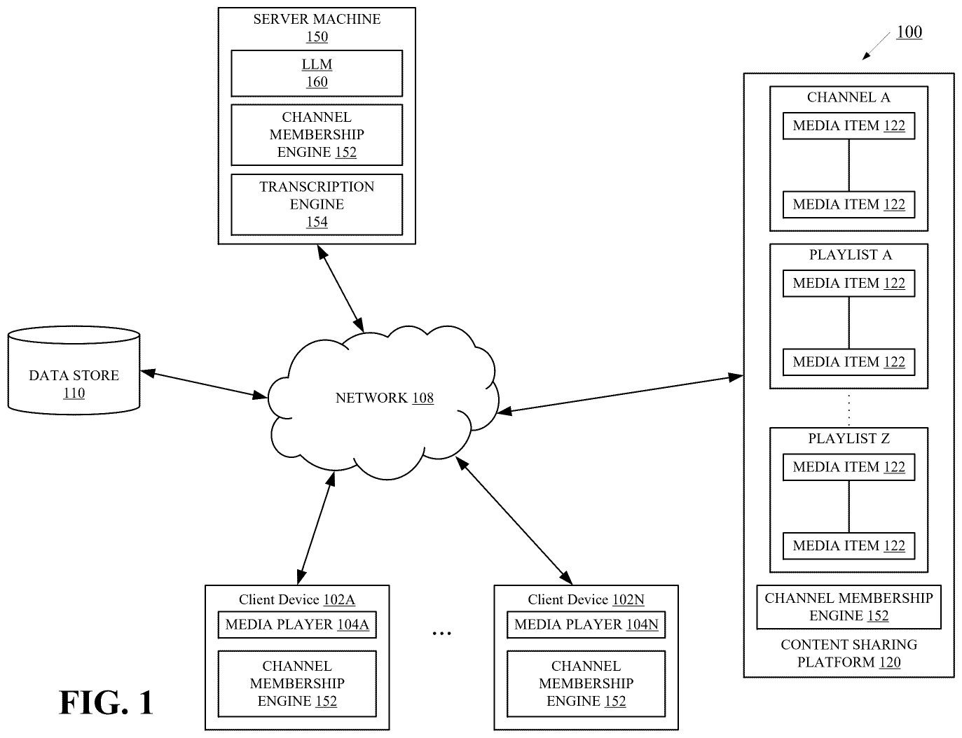

FIG. 1 illustrates an example system architecture 100, in accordance with implementations of the present disclosure. The system architecture 100 (also referred to as “system” herein) includes client devices 102A-102N, data store 110, content sharing platform 120, and/or server machine 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machine 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120. In some implementations, the applications can include channel membership engine 152 and/or transcription engine 154.

In some implementations, content sharing platform 120 and server machine 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102N. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who may be a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can provide input to enable channel memberships that provide one or more membership tiers on a channel. Each membership tier can allow “members” to join the channel through monthly fees and receive privileges (e.g., members-only benefits) that can include access to exclusive content, badges, emojis, access to live-streams, chats, etc. In some implementations, a particular channel can offer multiple membership tiers, where each tier or level can include different privileges for a different monthly fee.

In some implementations, content sharing platform 120 (and/or server machine 150 and/or client device 102A-102N) can include channel membership engine 152 that can generate offers to one or more channel owners of content sharing platform 120. In some implementations, an offer can include one or more sets of tier names for a channel member's channel. Each set can be referred to as a “tier name offer” and a tier name for each respective membership tier offered by the channel owner. While implementations of the present invention will refer to membership plan with two or more tiers, the present invention can also be used to generate names for memberships offering only one tier. In some implementations, the offer(s) can be presented on media player 104A-104N (e.g., on the user interface associated with a channel of a channel owner) and/or provided to the channel owner using other means.

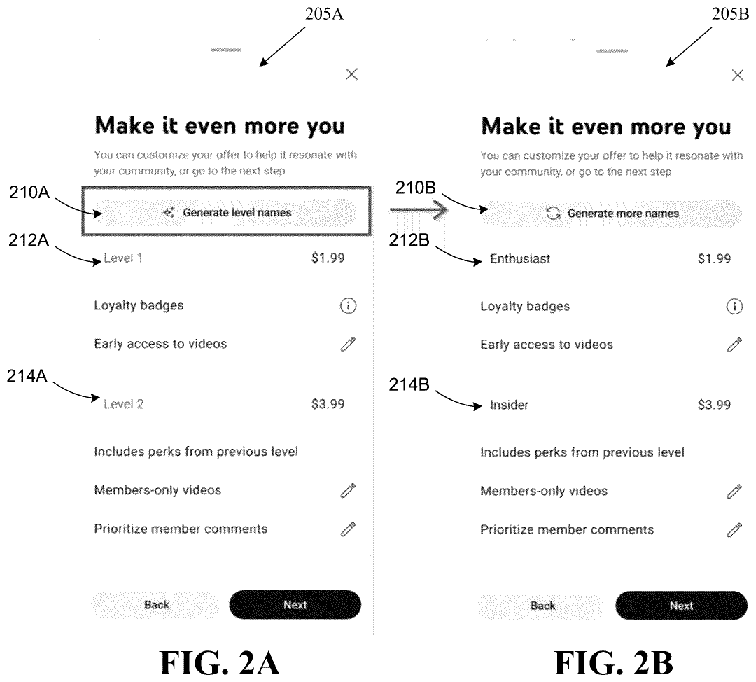

FIGS. 2A-B are example graphical user interfaces (GUIs) illustrating operation of an example tier name generation tool, in accordance with implementations of the present disclosure. In particular, FIGS. 2A-2B show GUIs 205A-205B which provide a channel owner with the option to automatically generate tier names. As shown in FIG. 2A, the channel owner is in the process of providing input to set up two membership tiers, where the first tier is initially referred to as level 1 in tier name field 212A and the second tier is initially referred to as level 2 in tier name field 214A. The first tier costs $1.99 per month and provides members with access to loyalty badges and early access to videos. The second tier provides members with the perks from the first tier, along with member-only videos and prioritized member comments. Button 210A allows the channel owner to request that tier names be generated for an initial set of tiers. For example, in response to the channel owner selecting button 210A, channel membership engine 152 generates the tier name “Enthusiast” in tier name field 212B for the first tier and the tier name “Insider” in tier name field 214B for the second tier. If the channel owner is satisfied with the generated names, they can accept the tier names and continue the setup process. Otherwise, the channel owner can manually edit either or both tier names or select button 210B to generate another set of tier names.

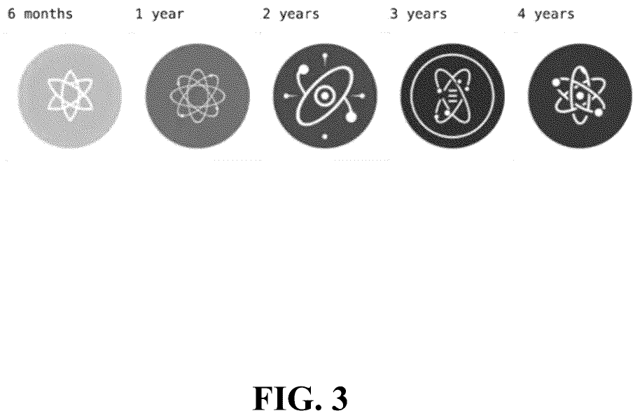

Returning to FIG. 1, in some implementations, channel membership engine 152 can provide, for different membership tiers, additional member offers including one or more custom items of exclusive content, such as, for example, a set of custom badges, a set of custom emojis, or any other content offered to members. Each set can be referred to as a “exclusive content offer.” In some implementations, the exclusive content offer can replace default content offered by channel memberships (e.g., default emojis, default badges, etc.). In other implementations, the exclusive content offer can be offered as supplemental content (e.g., in addition to the default content). FIG. 3 is a diagram showing an example set of custom badges, in accordance with implementations of the present disclosure. As shown, the set includes five badges for a channel offering science content. The badges can be given to members based on their tenure as members (e.g., a specific badge for being a member for six months, one year, two years, three years, and four years).

Returning to FIG. 1, in some implementations, the offers can be generated using data obtained from LLM 160. An LLM is a type of artificial intelligence (e.g., machine learning) model designed to understand and generate human-like text. In particular, LLM 160 can perform natural language processing tasks such as language translation, text summarization, question answering, etc. LLM 160 can be built on deep learning architectures, such as transformer models. In some implementations, LLM 160 can be generated through supervised learning, during which LLM 160 is trained on large datasets of text. The text can be gathered from various sources, such as books, articles, websites, content sharing platform contents (e.g., media item titles, comments, media item descriptions, etc.), and so forth.

In some implementations, a text dataset can be used to pre-train LLM 160 on a language modeling task where LLM 160 learns to predict the next word in a sequence of text given the previous words. This pre-training phase can be used to develop, for LLM 160, a deep understanding of language patterns and semantics. After pre-training, LLM 160 can be fine-tuned on specific tasks to specialize its capabilities. During fine-tuning, LLM 160 can be exposed to examples of the target task, such as text classification or language translation, corresponding labels or target outputs, etc. In some implementations, LLM 160 can adjust one or more parameters to minimize the difference between predictions and true outputs. The adjusting can be performed using iterative optimization techniques, such as, for example, gradient descent. The adjusting process can enable LLM 160 to adapt pre-learned knowledge to the nuances of the target task, making it more effective in real-world applications. In some implementations, LLM 160 can be used to generate one or more sets of tier name offers. This will be described in detail below.

In some implementations, LLM 160 can be pre-trained and/or fine-tuned on data (e.g., channel names, channel descriptions, media item titles, tier names, channel metadata, comments, replies, badges, emojis, etc.) from many different users, such as, for example, channel owners, viewers, members, etc. The channel name can refer to the name given to the channel by, for example, the channel owner. The channel description can refer to an “about” section that describes the channel owner, the type of content the channel offers, why viewers should consume media items from the channel, the purpose of the channel, etc. The media item titles can refer to the titles of each media item (e.g., each video) on a channel. The channel metadata can refer to descriptive data related to the channel. In some implementations, the channel metadata can be stored in a hierarchical structure. For example, a parent node can describe an overall theme of the subject matter offered by the channel (e.g., sports, gaming, arts, music, science, etc.), and one or more child nodes can describe a subdivision of the theme. For example, if the theme is sports, a first child node can describe the type of sport (e.g., hockey, soccer, paintball, etc.), a second child node can describe categories related to the specific types of sports (e.g., analysis, clips, etc.). The channel metadata can be auto-generated, user generated, or any combination thereof.

LLM 160 can thus serve as an LLM model fine-tuned to understand how content creators name tiers for their channel memberships. In some implementations, multiple LLMs can be trained based on groups of users having certain characteristics or of a certain location. For example, each LLM 160 can be pre-trained and/or fine-tuned based on a set of regional users (e.g., country, state, providence, etc.), a set of users with specific characteristics (e.g., age brackets, gender, race, language, interests, etc.), a set of interests (gaming, sports, arts, music, etc.), and so forth. In some implementations, LLM 160 can be periodically retrained (e.g., refined) using new data, such as, for example, tier names, media item titles, channel metadata, badges, emojis, etc.

In some implementations, LLM 160 can be trained using one or more audio related features (e.g., audio transcription data). Audio transcription data can include a transcription of the audio data from a segment of a media item (e.g., from a video) or from the entirety of the media item. In some implementations, transcription engine 154 can generate the audio transcription data using a text extractor system (e.g., software, an algorithm, etc.). For example, transcription engine 154 can convert audio data corresponding to a media item (or corresponding to one or more segments of the media item) into text data. Examples of the text extractor system can include a text-embedding model (e.g., the universal sentence embedding model), a speech recognition model, a speech-to-text model, etc. In some implementations, the audio transcription data can be generated by user input. For example, a user (e.g., a channel owner) can generate a transcript of the audio corresponding to one or more segments of a media item and/or to one or more media items. The transcript can be included, for example, as metadata related to the media item. In some implementations, the audio transcription data can be generated using an optical character recognition (OCR) system. An OCR system can include a software tool that converts visual data (e.g., images, frames, etc.) into editable and searchable text. In one example, an OCR system can generate text data from closed captions or subtitles associated with a media item 122 (e.g., if such closed captions or subtitles associated with the media item 122 are not otherwise available).

In some implementations, in order to generate tier name offers and/or exclusive content offers, channel membership engine 152 can instruct LLM 160 to perform one or more tasks. A task can refer to the type of data or analysis desired from LLM 160. The tasks can include, for example, determining the content of a channel, generating one or more sets of tier name offers, generating one or more sets of exclusive content offers, selecting one or more subsets from a generated set of tier name offers, filtering one or more of the sets or subsets, using a particular format for generating output data, etc.

The output format can reflect how the LLM 160 is to provide the data it was tasked to obtain. In some implementations, the output format can instruct LLM 160 how many tier name offers are to be in a set (e.g., generate 100 sets of tier name offer, each offer include three tier names), the type of content to be included in the output data (e.g., a summary of the channel content, the number of sets to be included), which file format to use when providing the output data (e.g., present the data in JavaScript Object Notation (JSON) format, YAML Ain't Markup Language (YMAL), etc.).

Channel membership engine 152 can then obtain, as output from LLM 160, data reflecting one or more of the summaries of the channel content, data reflecting one or more sets or subsets of tier name offers, etc. Channel membership engine 152 can then supply one or more sets of tier names for each corresponding tier when a channel owner is setting up the membership tiers on their channel. This allows the channel owner to auto-generate the tier names. Channel membership engine 152 can also supply one or more sets of exclusive content offers for each tier and/or channel.

In some implementations, other AI models can be used in place or in addition to LLM 160, such as deep networks. An example of a deep network is a neural network with one or more hidden layers, and such an AI model can be trained by, for example, adjusting weights of a neural network in accordance with a backpropagation learning algorithm or the like. In other or similar implementations, the AI model can be created by finding patterns in training data, identifying clusters of data that correspond to the identified patterns, and providing the AI models that capture these patterns. Some AI models can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

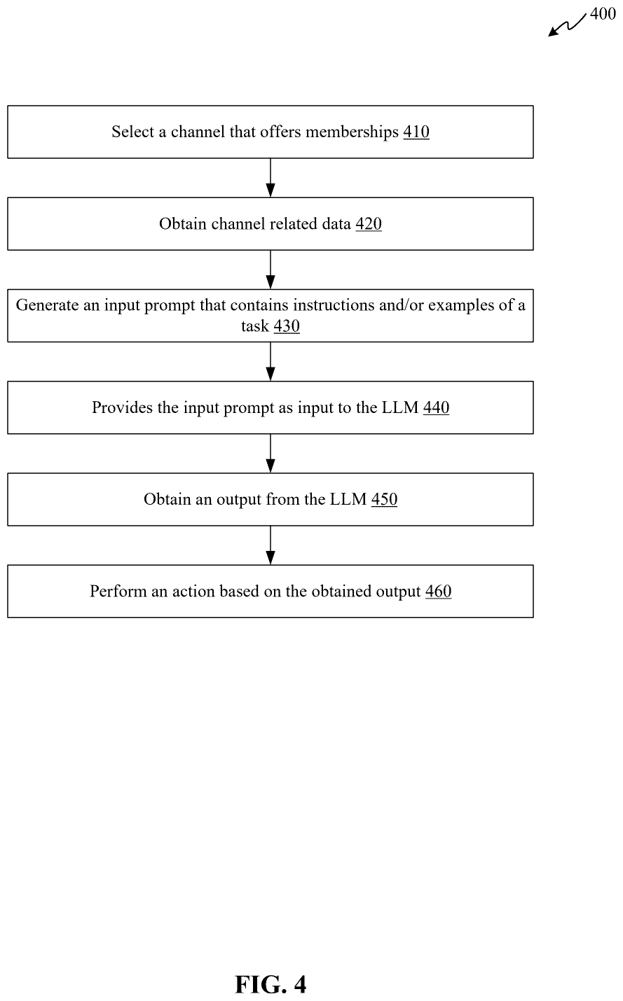

FIG. 4 depicts a flow diagram of an example method 400 for generating tier name offers, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some implementations, some or all of the operations of method 400 can be performed by channel membership engine 152, as described above.

For simplicity of explanation, method 400, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 400 in accordance with the disclosed subject matter. In addition, those skilled in the art will understand and appreciate that method 400 could alternatively be represented as a series of interrelated states via a state diagram or events. Additionally, it should be appreciated that method 400 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 410, processing logic selects a channel that offers memberships. The channel can be selected at random, based on a predetermined criterion (e.g., age of the channel, geographic region of the channel, type of channel, channel owner input, etc.). In some instances, the processing logic can select a channel and then determine whether the channel offers memberships (e.g., offers at least one membership tier). Responsive to the processing logic determining that the channel does not offer memberships, the processing logic can select another channel. In some implementations, the processing logic can select the channel in response to the channel being eligible to offer memberships. For example, the processing logic can determine whether the channel and/or channel owner satisfy certain eligibility criteria. In some implementations, the eligibility criteria can relate to the number of subscribers to the channel, the number of public watch hours over a particular time period (e.g., 100 public watch hours over the previous month), the type of content offered, etc. Responsive to the processing logic determining that the channel is not eligible to offer channel memberships to viewers, the processing logic can select another channel. Responsive to the processing logic determining that the channel is eligible to offer channel memberships to viewers, the processing logic proceeds to operation 420.

At operation 420, processing logic obtains channel related data. The channel related data can include the channel name, a description of the channel, one or more media item titles, channel metadata, one or more audio related features (e.g., audio transcription data), etc. In some implementations, the obtained data can be limited to certain criteria. For example, the media item titles can be limited to the last ten media items posted on the channel, to the fifteen most popular (e.g., most liked, highest like to dislike ratio, etc.) media items, etc.

At operation 430, processing logic generates an input prompt that contains instructions and/or examples of a task. The input prompt can serve to guide the output of LLM 160.

In some implementations, the input prompt can include content instructions. Content instructions can be used to inform an LLM (e.g., LLM 160) about the type of conversation LLM 160 is engaging in and/or the function LLM 160 is to perform. The context instructions can be used to aid LLM 160 in avoiding lengthy replies, consistently generating readable text, expediting operations, etc. In an illustrative example, context instructions can include the following prompt:
Channel memberships are a way for viewers to directly support a channel through recurring monthly payments. Members get access to exclusive content and perks that the channel owner can define when setting up the channel memberships on their channel. The channel owner can set up multiple tiers in their channel offer. The higher the tier, the more expensive it is, but the more perks a member receives. Each membership tier is required to have a name that the channel owner provides.

In some implementations, the input prompt can include task instructions. Task instructions can be used to identify the type of data or analysis desired from LLM 160. In an illustrative example, task instructions can include the following prompt:
Your task is to generate 10 sets of three tier name offers (triplets) for a channel owner who is offering channel memberships on their channel. The tier name offers should be in English and related to the content that the channel owner produces on their channel. For each triplet, there should be some kind of progression in the naming that reflects that higher tiers usually provide members with a higher value. Avoid wording that may come across as rude, disrespectful, or hurtful.

In some implementations, the input prompt can include an expected input format. The input format can reflect how LLM 160 is to receive data. In an illustrative example, input format can include the following prompt:
The input format is JSON (JavaScript Object Notation) format, where you will be provided with: a description of the channel and a list of video titles from videos on the channel.

In some implementations, the input prompt can include a desired output format. The output format can reflect how LLM 160 is to structure the output data. In an illustrative example, output format can include the following prompt:
The output format should be valid JSON that contains a list of 10 triplets (each containing the three names for tier 1, 2, and 3) and a quick summary of the channel's content.

In some implementations, the input prompt can include one or more examples. The examples can provide additional context to LLM 160, such as, for example, how LLM 160 should answer. In particular, the examples can illustrate to LLM 160 the type of data desired, the type of format desired, example input data and correlating output data, etc.

In some implementations, the input prompt can include distinction data. The distinction data can be used to instruct LLM 160 of non-desired answers.

In some implementations, the input prompt can include audio related feature data (e.g., audio transcription data or the media item itself) related to certain media items on the channel.

In some implementations, the input prompt can include instructions to generate one or more sets of exclusive content offers. For example, the input prompt can include the task of generating a set of badges for the channel, generating a set of emojis for each tier and/or the channel, etc.

At operation 440, processing logic provides the input prompt as input to LLM 160. For example, processing logic 440 provides the input prompt including the content described above and instructions to the LLM to perform the requested task.

In some implementations, a set of prompts can be provided as input, where each subsequent prompt provided as input includes output data previously obtained from LLM 160. For example, processing logic can generate a first prompt as input to LLM 160, where the first prompt includes a first task of generating a summary of the channel content using, for example, the channel description, channel metadata, and a set of media item titles. Processing logic can then generate a second prompt as input to LLM 160, where the second prompt includes a second task of generating, based on the channel content data received, a specific number of sets (e.g., 50, 100, 200, etc.) of tier name offers where each set includes a specific number of tier names (e.g., two tier names, three tier names, four tier names, etc.). Processing logic can then generate a third prompt as input to LLM 160, where the third prompt includes a third task of selecting, from the generated number of sets of tier name offers, a subset of tier name offers (e.g., the best 20 sets, 30 sets, 40 sets, etc.) while filtering out tier name offers that include sensitive wording (e.g., words that are offensive, rude, disrespectful, hurtful, sexual, etc.). In some implementations, LLM 160 represents multiple LLMs to perform different tasks based on different prompts—e.g., a first LLM may receive the first prompt, a second LLM may receive the second prompt, and a third LLM receives the third prompt.

At operation 450, processing logic obtains an output from LLM 160. The output can reflect the results generated by LLM 160 from performing the requested task. In some implementations, the output can be in the format that LLM 160 was requested to use.

At operation 460, processing logic performs an action based on the obtained output. In some implementations, such as those where the output is generated in response to channel owner selecting the generate names button (e.g., button 210A or button 210B), the processing logic can pre-fill, based on the obtained output, the tier name field related to the membership tiers. In some implementations, the processing logic can store the obtained output and pre-fill the tier names field once the channel owner selects the generate names button. This allows the names to be produced instantly rather than the LLM generating a new set. In some implementations, the action can include selecting a set of exclusive content offers. The items of the set of exclusive content offers (e.g., the badges, the emojis, etc.) can then be added as perks for the members and/or replace the default perks.

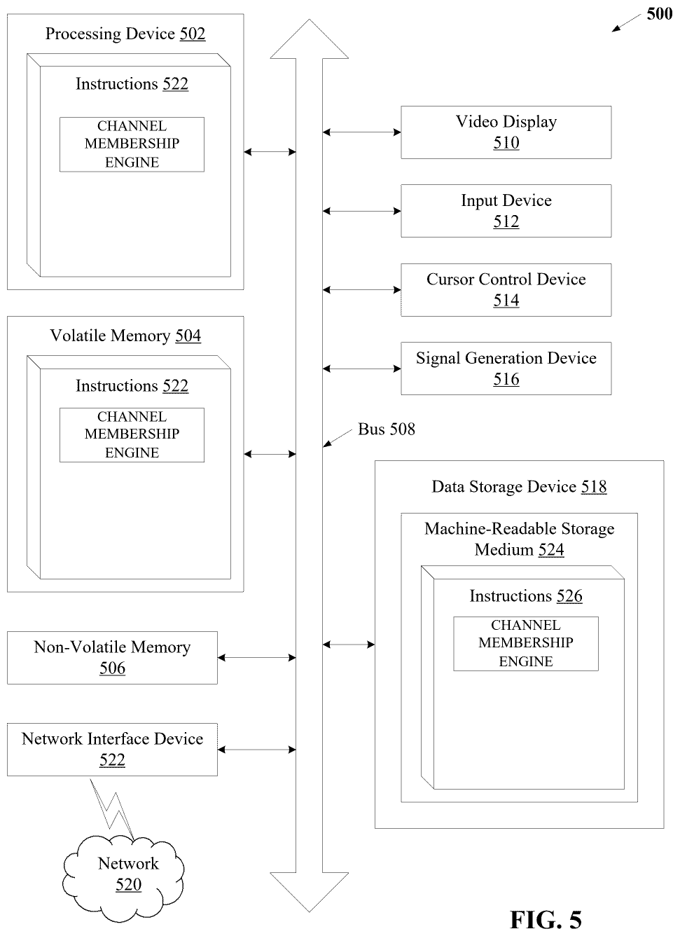

FIG. 5 depicts a block diagram of a computer system operating in accordance with one or more aspects of the present disclosure. In certain implementations, computer system 500 can be connected (e.g., via a network, such as a Local Area Network (LAN), an intranet, an extranet, or the Internet) to other computer systems. Computer system 500 can operate in the capacity of a client device. Computer system 500 can operate in the capacity of a server or a client computer in a client-server environment. Computer system 500 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 can include a processing device 502, a volatile memory 504 (e.g., random access memory (RAM)), a non-volatile memory 506 (e.g., read-only memory (ROM) or electrically erasable programmable ROM (EEPROM)), and a data storage device 518, which can communicate with each other via a bus 508.

Processing device 502 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 can further include a network interface device 522. Computer system 500 also can include a video display unit 510 (e.g., an LCD), an input device 512 (e.g., a keyboard, an alphanumeric keyboard, a motion sensing input device, touch screen), a cursor control device 514 (e.g., a mouse), and a signal generation device 516.

Data storage device 518 can include a non-transitory machine-readable storage medium 524 on which can store instructions 526 encoding any one or more of the methods or functions described herein, including instructions encoding components of client device of FIG. 1 for implementing method 400.

Instructions 526 can also reside, completely or partially, within volatile memory 504 and/or within processing device 502 during execution thereof by computer system 500, hence, volatile memory 504 and processing device 502 can also constitute machine-readable storage media.

While machine-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform method 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processing device of a content sharing platform, a channel that offers a plurality of membership tiers to users of the content sharing platform;
generating, using one or more artificial intelligence (AI) models and a first prompt, data pertaining to content of the channel;
determining, for each membership tier of the plurality of membership tiers, using the one or more AI models and a second prompt, a set of names reflecting the content of the channel;
generating, for each membership tier, a recommendation reflecting a respective name selected from the set of names; and
pre-filling, based on the recommendation, a respective tier name field associated with each membership tier.

2. The method of claim 1, wherein the first prompt is generated automatically based on a channel owner request to generate membership tier names for the channel, and comprises instructions to summarize the content of the channel.

3. The method of claim 2, wherein the first prompt further comprises a description of the channel, identifiers of media items of the channel, and metadata related to the channel.

4. The method of claim 3, wherein the identifiers of the media items of the channel comprise one or more of titles of recent media items of the channel or titles of popular items of the channel, and wherein the metadata related to the channel comprises one or more of a content type of media items of the channel, or information about an owner of the channel.

5. The method of claim 1, wherein the second prompt is generated automatically and comprises instructions that the set of names includes a progression in naming which reflects that higher tiers provide members with a higher value.

6. The method of claim 5, wherein the second prompt further comprises a summary of the content of the channel, wherein the data pertaining to the content of the channel comprises the summary of the content of the channel.

7. The method of claim 5, wherein the second prompt further comprises a type of format to structure the set of names.

8. The method of claim 1, further comprising:
removing, using the one or more AI models, a name from the set of names due to the name comprising a sensitive word.

9. The method of claim 1, wherein the recommendation further comprises, for each membership tier, a respective set of badges or a respective set of emojis to be provided to members of the channel.

10. A system comprising:
a memory; and
a processing device, coupled to the memory, the processing device to perform operations comprising:
identifying a channel that offers a plurality of membership tiers to users of a content sharing platform;
generating, using one or more artificial intelligence (AI) models and a first prompt, data pertaining to content of the channel;
determining, for each membership tier of the plurality of membership tiers, using the one or more AI models and a second prompt, a set of names reflecting the content of the channel;
generating, for each membership tier, a recommendation reflecting a respective name selected from the set of names; and
pre-filling, based on the recommendation, a respective tier name field associated with each membership tier.

11. The system of claim 10, wherein the first prompt is generated automatically based on a channel owner request to generate membership tier names for the channel, and comprises instructions to summarize the content of the channel.

12. The system of claim 11, wherein the first prompt further comprises a description of the channel, identifiers of media items of the channel, and metadata related to the channel.

13. The system of claim 12, wherein the identifiers of the media items of the channel comprise one or more of titles of recent media items of the channel or titles of popular items of the channel, and wherein the metadata related to the channel comprises one or more of a content type of media items of the channel, or information about an owner of the channel.

14. The system of claim 10, wherein the second prompt is generated automatically and comprises instructions that the set of names includes a progression in naming which reflects that higher tiers provide members with a higher value.

15. The system of claim 14, wherein the second prompt further comprises a summary of the content of the channel, wherein the data pertaining to the content of the channel comprises the summary of the content of the channel.

16. The system of claim 14, wherein the second prompt further comprises a type of format to structure the set of names.

17. The system of claim 10, further the operations further comprise:
removing, using the one or more AI models, a name from the set of names due to the name comprising a sensitive word.

18. The system of claim 10, wherein the recommendation further comprises, for each membership tier, a respective set of badges or a respective set of emojis to be provided to members of the channel.

19. A non-transitory computer-readable medium comprising instructions that, responsive to execution by a processing device, cause the processing device to perform operations comprising:
Identifying a channel that offers a plurality of membership tiers to users of a content sharing platform;
generating, using one or more artificial intelligence (AI) models and a first prompt, data pertaining to content of the channel;
determining, for each membership tier of the plurality of membership tiers, using the one or more AI models and a second prompt, a set of names reflecting the content of the channel;
generating, for each membership tier, a recommendation reflecting a respective name selected from the set of names; and
pre-filling, based on the recommendation, a respective tier name field associated with each membership tier.

20. The non-transitory computer readable storage medium of claim 19, wherein the second prompt is generated automatically and comprises instructions that the set of names includes a progression in naming which reflects that higher tiers provide members with a higher value.
